(19) United States
(12) Patent Application Publication
(10) Pub. No.: US 2007/0273278 A1
(43) Pub. Date: Nov. 29, 2007

(54) Reflective organic electroluminescence panel and display

(76) Inventor: Min-Chieh Hu, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/458,683

(22) Filed: Jul. 20, 2006

(30) Foreign Application Priority Data
May 25, 2006 (TW) 095118667

(51) Int. Cl. H01J 1/62

(52) U.S. Cl. 313/506; 313/504; 313/512

(57) ABSTRACT

A reflective organic electroluminescence panel has a first transparent substrate, a pair of first transparent electrodes disposed on one side of the first transparent substrate, a first luminescence layer disposed between the first transparent electrodes, a second transparent electrode disposed on the other side of the first transparent substrate, a reflective electrode disposed on one side of the second transparent electrode opposite to the first transparent substrate, and a second luminescence layer disposed between the second transparent electrode and the reflective electrode.

### BACKGROUND OF THE INVENTION

1. Field of the Invention

The present invention relates to an organic electroluminescence display (OEL display), and more particularly, to an organic electroluminescence display having high brightness and a long lifespan.

2. Description of the Prior Art

Flat panel displays have advantages, which the traditional Cathode Ray Tube (CRT) displays cannot match, such as low power consumption, no radiation, lightweight, thinness and shortness. Therefore flat panel displays are gradually replacing the CRT. With the improvement of flat panel displays techniques, the prices of flat panel displays are getting lower. Flat panel displays will become more widespread and will continue to be developed to larger sizes. Among all kinds of flat panel displays nowadays, due to having the advantage of high contrast, the organic electroluminescence display is the most expectative product in the present market.

Please refer to FIG. 1. FIG. 1 is a schematic diagram of the electroluminescence panel. As shown in FIG. 1, the electroluminescence panel 10 comprises a substrate 12, a first transparent electrode (anode) 14 disposed on the surface of the substrate 12, a luminescence layer 16 disposed on the surface of the first transparent electrode 14, and a second transparent electrode (cathode) 18 disposed on the surface of the luminescence layer 16.

The luminescence theory of the electroluminescence panel 10 is described as follows. When there is a bias that exists between first transparent electrode 14 and second transparent electrode 18, holes will go into the luminescence layer 16 having luminous characteristics from the first transparent electrode 14. Similarly, electrons will also go into the luminescence layer 16 from the second transparent electrode 18. When electrons and holes recombine in the luminescence layer 16, they will generate excitons. Then they release energy and go back to the ground state. Parts of released energy will be released as different color-light forms and generate the luminous phenomenon in electroluminescence panel 10.

With regard to electroluminescence panel, if a highly bright display is to be formed, high driving voltage has to be held. However, a high driving voltage not only consumes electrical power, but also critically affects the lifespan of the panel.

### SUMMARY OF THE INVENTION

The present invention provides a reflective organic electroluminescence panel and display with increasing brightness and extending lifespan.

For the purpose of descriptions above, the present invention provides a reflective organic electroluminescence panel. The reflective organic electroluminescence panel comprises a first transparent substrate, a pair of first transparent electrodes disposed on one side of first transparent substrate, a first luminescence layer disposed between the first transparent electrodes, a second transparent electrode disposed on the other side of the first transparent substrate, a reflective electrode disposed on one side of the second transparent electrode opposite to the first transparent substrate, and a second luminescence layer disposed between the second transparent electrode and the reflective electrode.

For the purpose of the above-mentioned, the present invention provides an organic electroluminescence display. The organic electroluminescence display comprises the former mentioned reflective organic electroluminescence panel and a transmissive electroluminescence panel disposed on the reflective organic electroluminescence panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electroluminescence panel.

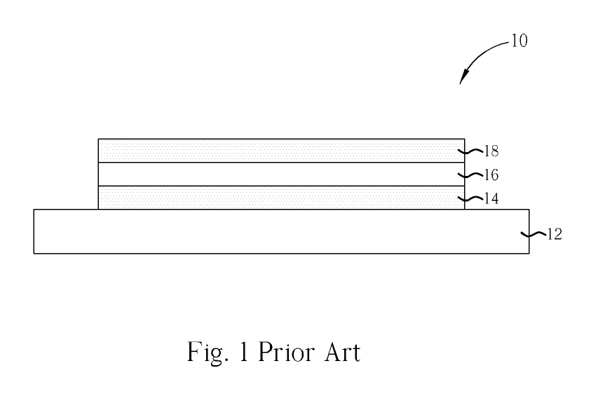

FIG. 2 is a schematic diagram illustrating a reflective organic electroluminescence panel according to a first preferred embodiment of the present invention.

FIG. 3 is a schematic diagram illustrating an organic electroluminescence display according to a second preferred embodiment of the present invention.

### DETAILED DESCRIPTION

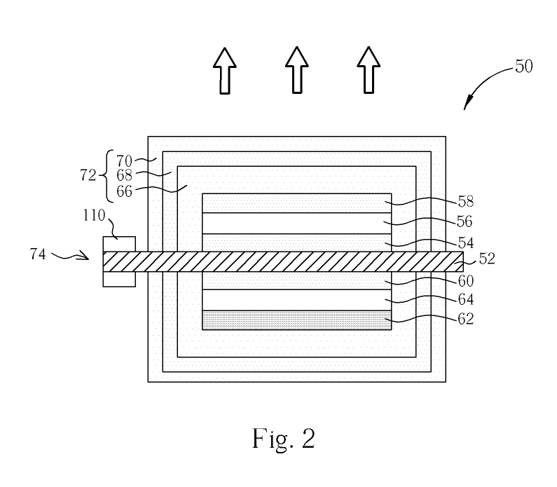

Please refer to FIG. 2. FIG. 2 is a schematic diagram illustrating a reflective organic electroluminescence panel according to a first preferred embodiment of the present invention. As shown in FIG. 2, the preferred embodiment of the reflective organic electroluminescence panel 50 comprises a first transparent substrate 52, a pair of first transparent electrodes 54,58 disposed on one side of the first transparent substrate 52, a first luminescence layer 56 disposed between the first transparent electrodes 54,58, a second transparent electrode 60 disposed on one side of the first substrate 52, a reflective electrode 62 disposed on the other side of the second transparent electrode 60 opposite to the first transparent substrate 52, and a second luminescence layer 64 disposed between the second transparent electrode 60 and the reflective electrode 62. Also, in the embodiment the reflective organic electroluminescence panel 50 comprises a protection layer 72, constituted by an organic material layer 66, a silicon oxide layer 68, and a silicon nitride layer 70, which encapsulates and protects the reflective organic electroluminescence panel 50. The reflective organic electroluminescence panel 50 further includes an external control device connection area 74 used to connect the reflective organic electroluminescence panel 50 and at least one external control device 110 disposed on the first transparent substrate 52.

The reflective organic electroluminescence panel 50 of the present invention is a single-side display panel. In addition, the display surface faces in the direction of the arrow sign shown in FIG. 2. The first luminescence unit of the reflective organic electroluminescence panel 50 is composed of the first transparent electrodes 54,58 and the first luminescence layer 56 disposed between the first transparent electrodes 54,58. Because the first transparent electrodes 54,58 are transparent conductive material, the first luminescence layer 56 will generate the light that radiates up and down separately when the image is displaying. Moreover, the light emitted upward directly provides part of the brightness, and the light emitted downward will pass through the first transparent substrate 52, and then the light will be reflected by the reflective electrode 62 to the direction of the display surface in order to provide part of the brightness. On the other hand, disposed on one side of the first transparent substrate 52 are the second transparent electrode 60, the reflective electrode 62, and a second luminescence layer 64, which constitute the second luminescence unit of the reflective organic electroluminescence panel 50. The light generated by the second luminescence layer 64 also will emit upward and downward. The light emitted upward will pass through the first transparent substrate 52 to the display surface and contribute to the part of the brightness. The light emitted downward will be reflected by the reflective electrode to the direction of display surface and provide part of the brightness. Therefore, the reflective organic electroluminescence panel 50 according to the embodiment generates the brightness that is provided by two simultaneous emitting luminescence units. For this reason, the brightness can reach over twice as bright as the bright of a luminescence unit of the electroluminescence panel.

The transparent substrate of the reflective organic electroluminescence panel according to the embodiment can be inorganic transparent material, such as glass, quartz, or organic transparent material, such as plastic. Transparent electrodes can be made out of transparent conductive material, such as AINd or indium tin oxide. The reflective electrode can be made out of material having good conductivity and reflectivity, such as silver, nickel, gold, or platinum. The material of the luminescence layer can be organic luminous material or polymer luminous material. Otherwise, the protection layer of the embodiment is a multi-layer structure composed of organic material, silicon oxide, and silicon nitride. However, the protection layer also can be a single layer structure whose material can be any suitable material. In addition, in order to improving the injection and transport efficiency of holes and electrons, it depends on requirements to dispose the hole injection layer, the hole transport layer, the electron injection layer and the electron transport layer between the luminescence layer and the electrode. Besides, the reflective organic electroluminescence panel can be an active or passive organic light emitting diode display panel or a polymer light emitting diode display panel.

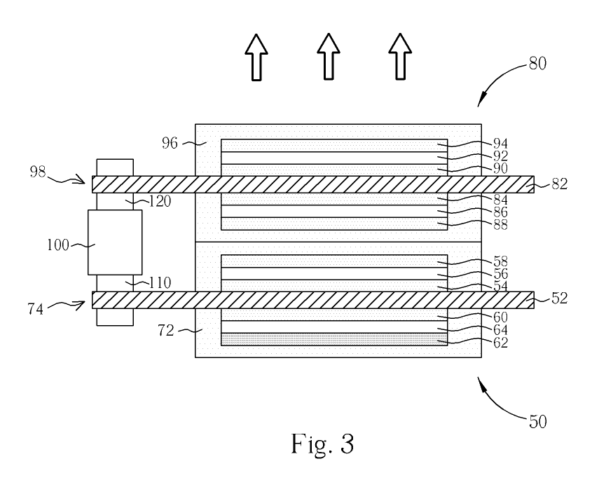

Please refer to FIG. 3. FIG. 3 is a schematic diagram illustrating the organic electroluminescence display according to a second preferred embodiment of the present invention. The organic electroluminescence display of the embodiment comprises a reflective organic electroluminescence panel of the above-mentioned embodiment. Further, the same device is used by the same device symbol. As shown in FIG. 3, the organic electroluminescence display of the embodiment comprises a reflective organic electroluminescence panel 50, and a transmissive organic electroluminescence panel 80 disposed on the reflective organic electroluminescence panel 50. The reflective organic electroluminescence panel 50 comprises a first transparent substrate 52, a pair of first transparent electrodes 54,58 disposed on one side of first transparent substrate 52, a first luminescence layer 56 disposed between the first transparent electrodes, a second transparent electrode 60 disposed on one side of the first substrate 52, a reflective electrode 62 disposed on the other side of the second transparent electrode 60 opposite to the first transparent substrate 52, and a second luminescence layer 64 disposed between the second transparent electrode 60 and the reflective electrode 62. Besides, the reflective organic electroluminescence panel 50 also comprises a protection layer encapsulating and protecting the reflective organic electroluminescence panel 50 and an external control device connection area 74 disposed on the first transparent substrate 52.

The transmissive organic electroluminescence panel 80 comprises a second transparent substrate 82, a pair of third transparent electrodes 84,88 disposed on one side of second transparent substrate 82 facing the reflective organic electroluminescence panel 50, a third luminescence layer 86 disposed between the third transparent electrodes 84,88, a pair of fourth transparent electrodes 90,94 disposed on the other side of second transparent substrate 82 opposite to the reflective organic electroluminescence panel 50 and a fourth luminescence layer 92 disposed between the fourth transparent electrodes 90,94. Otherwise, the transmissive organic electroluminescence panel 80 also comprises a protection layer 96 encapsulating and protecting transmissive organic electroluminescence panel 80 and an external control device connection area 98 used for receiving the signal from at least one external control device 120 disposed on the second transparent substrate 82. Besides, in the embodiment the external control device connection area 74 of the reflective organic electroluminescence panel 50 and the external control device connection area 98 of the transmissive organic electroluminescence panel 80 are connected with electricity by making use of a conductive connecting device 100. For this reason, the reflective organic electroluminescence panel 50 and the transmissive organic electroluminescence panel 80 can be driven by the same control circuits. However, applications of the present invention are not restricted to this embodiment only. Therefore, the external control device connection area 74 of the reflective organic electroluminescence panel 50 and the external control device connection area 98 of the transmissive organic electroluminescence panel 80 do not need to be connected with electricity, and instead, can be controlled with an independent way.

According to FIG. 3, the organic electroluminescence display of the embodiment comprises a reflective organic electroluminescence panel 50, and a transmissive organic electroluminescence panel 80. In addition, two sides of the first transparent substrate 52 of the reflective organic electroluminescence panel 50 and two sides of the second transparent substrate 82 of the transmissive organic electroluminescence panel 80 all comprise luminescence units. Therefore, because the organic electroluminescence display has rather four luminescence units, display brightness could be four times the brightness of an electroluminescence panel that has only one luminescence unit. The organic electroluminescence display of the embodiment is not only restricted by using a transmissive organic electroluminescence panel 80, but also combines several transmissive organic electroluminescence panels 80 according to the demands of brightness specification. In other words, the organic electroluminescence display of the embodiment regards a reflective organic electroluminescence panel 50 as a basic unit. According to the brightness demands, combining one or several transmissive organic electroluminescence panels 80 could improve brightness performance. Under the operating conditions, for the reflective organic electroluminescence panel 50 and the transmissive organic electroluminescence panel 80, it is unnecessary to use high driving voltage way to improve brightness. Therefore, the total brightness of the organic electroluminescence display can be substantially improved, and the lifespan of the organic electroluminescence display can be extended.

In summary, the organic electroluminescence display of the present invention has advantages of high brightness and long lifespan. In addition, it is easier to guide into production by using the module method of combining the reflective organic electroluminescence panel and the transmissive organic electroluminescence panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reflective organic electroluminescence panel, comprising:
a first transparent substrate;
a pair of first transparent electrodes disposed on a side of the first transparent substrate;
a first luminescence layer disposed between the first transparent electrodes;
a second transparent electrode disposed on the other side of the first transparent substrate;
a reflective electrode disposed on a side of the second transparent electrode opposite to the first transparent substrate; and
a second luminescence layer disposed between the second transparent electrode and the reflective electrode.

2. The reflective organic electroluminescence panel of claim 1, further comprising an external control device connection area for connecting to an external control device disposed on the first transparent substrate.

3. The reflective organic electroluminescence panel of claim 1, further comprising a protection layer encapsulating the reflective organic electroluminescence panel.

4. The reflective organic electroluminescence panel of claim 3, wherein the protection layer is a single-layer structure.

5. The reflective organic electroluminescence panel of claim 3, wherein the protection layer is a multiple-layer structure.

6. An organic electroluminescence display comprising:
the reflective organic electroluminescence panel of claim 1; and
a transmissive organic electroluminescence panel disposed on the reflective organic electroluminescence panel.

7. The organic electroluminescence display of claim 6, further comprising at least one protection layer encapsulating the transmissive organic electroluminescence panel.

8. The organic electroluminescence display of claim 6, wherein the transmissive organic electroluminescence panel comprises:
a second transparent substrate;
a pair of third transparent electrodes disposed on a side of the reflective organic electroluminescence panel facing the second transparent substrate; and
a third luminescence layer disposed between the pair of third transparent electrodes.

9. The organic electroluminescence display of claim 8, wherein the transmissive organic electroluminescence panel further comprises:
a pair of fourth transparent electrodes disposed on a side of the reflective organic electroluminescence panel opposite to the second transparent substrate; and
a fourth luminescence layer disposed between the pair of fourth transparent electrodes.

10. The organic electroluminescence display of claim 8 further comprising an external control device connection area for connecting to an external control device disposed on the second transparent substrate.
